(19) United States
(12) Patent Application Publication
(10) Pub. No.: US 2004/0033924 A1
(43) Pub. Date: Feb. 19, 2004

(54) Methods for conferring fabric care benefits during laundering

(76) Inventors: Dennis Stephen Murphy, Wykoff, NJ (US); Robert Joseph Ahart, Mahwah, NJ (US); Olga Companioni, North Bergen, NJ (US); Tamara Padron, North Bergen, NJ (US); Michael Orchowski, Nutley, NJ (US); Nick Agrawal, Lyndhurst, NJ (US)

Correspondence Address: UNILEVER, PATENT DEPARTMENT, 45 RIVER ROAD, EDGEWATER, NJ, 07020, US

(21) Appl. No.: 10/218,541

(22) Filed: Aug. 14, 2002

(51) Int. Cl. C11D 17/00

(52) U.S. Cl. 510/421; 510/267

(57) ABSTRACT

A method of laundering clothes is disclosed which relates to the inclusion of one or more color fading and fabric wear reducing ingredients in a laundry detergent product. The benefits are delivered to the laundered item during the cleaning step. A laundry detergent kit is also disclosed.

### BACKGROUND OF THE INVENTION

1. Field of the Invention

The present invention relates to the use of a laundry detergent composition suitable for laundering textiles, such as clothing, linens and the like which also confers fabric care benefits. In particular, it relates to the use of a laundry detergent composition that confers reduced color fading and fabric wear benefits to the laundered articles.

2. The Related Art

Color fading and fabric wear reduction techniques, such as turning garments inside out during washing, have been used but can be ineffective and inconvenient. Known attempts to reduce color fading and fabric wear by means of chemical ingredients in the wash include the use of dye transfer inhibitors such as polyvinylpyrrolidone and cellulase enzymes, etc. However, each of these ingredients have one or more drawbacks. For example, polyvinylpyrrolidone only is effective on certain dyes.

Therefore, there is a need for an effective and efficient means for color fading and fabric wear reduction in textiles during the laundering process. To be effective and efficient, the ingredient should preferably work across a broad range of water temperatures, and wash cycle conditions, have little to no discoloration effect on the laundered item and provide a noticeable color fading and fabric wear reducing benefit after relatively few wash cycles.

### SUMMARY OF THE INVENTION

The present application relates to the inclusion of one or more color fading and fabric wear reducing ingredients in a laundry detergent product. The benefits are delivered to the laundered item during the cleaning step. The color fading and fabric wear reduction benefits are especially noticeable after the laundered clothing has been dried by any suitable method including line drying, tumble drying, and the like.

While not wishing to be bound by the following hypothetical mechanism, the inventive silicone compounds and hydrophilically modified polymers and oils that facilitate the benefit of color fading and fabric wear reduction are believed to lubricate fiber surfaces. By lubricating the fiber surfaces of garments, for example, the fibers slide more easily relative to each other and are less likely to entangle, resulting less pilling and other signs of fabric wear. The inventive fiber lubricants also overcome one or more of the above noted disadvantages of prior color fading and fabric wear reducing agents or methods.

While it is known that certain lubricants can be used to reduce color fading and fabric wear reduction in textiles—see, for example, PCT WO 01/61100 to Frankenbach, et al., published on Aug. 23, 2001 and titled “Polymer Compositions Having Specified Ph For Improved Dispensing And Improved Stability Of Wrinkle Reducing Compositions And Methods Of Use” incorporated herein by reference, it was surprisingly found that the inventive materials work from a main wash detergent. More particularly, main wash detergents are highly diluted and are subject to one or more rinse cycles. Such high dilution and rinsing would be expected to diminish or eliminate the desired color fading and fabric wear reduction effect of the lubricant.

In one aspect of the invention is a method of reducing the color fading and fabric wear damage to laundered fabric that is subjected to multiple wash cycles, comprising the steps of:

providing a detergent composition comprising at least one color fading and fabric wear reducing agent selected from polyalkyleneoxide modified polydimethylsiloxane, linear aminopolydimethylsiloxane polyalkyleneoxide copolymers, high molecular weight polyacrylamides, betaine siloxane copolymers, alkylactam siloxane coplymers, and water soluble or dispersible triglyceride oils;

contacting the detergent composition with clothing during a washing procedure; and

allowing the clothing to dry; wherein the laundered clothing has less visible color fading and fabric wear than clothing laundered and dried in a similar manner with a detergent composition that excludes the at least one color fading and fabric wear reducing agent.

In another aspect of the invention is a method of reducing the occurrence of color fading and fabric wear damage in laundered clothing comprising:

providing a detergent formulation comprising at least one color fading and fabric wear reducing agent selected from compounds that to do not have a net positive charge;

contacting the detergent formulation with clothing during a washing procedure; and

allowing the clothing to dry; wherein the laundered clothing has less visible color fading and fabric wear than clothing laundered and dried in a similar manner with a detergent formulation that excludes the at least one color fading and fabric wear reducing agent.

In a further aspect of the invention is a laundry detergent composition kit comprising:

a laundry detergent composition including at least one surfactant;

at least one color fading and fabric wear reducing agent;

the laundry detergent composition and color fading and fabric wear reducing agent packaged in at least one container;

instructions to use the laundry detergent composition and color fading and fabric wear reducing agent at a level that will provide from about 10 to 780 ppm, preferably from about 20 to 360 ppm, of the color fading and fabric wear reducing agent in the aqueous wash solution to provide a benefit that color fading and fabric wear is reduced in a fabric as compared to a comparable treatment with a lower level of, or the absence of the color fading and fabric wear reducing agent.

### DETAILED DESCRIPTION

Triglyceride color fading and fabric wear reducing agents are suitably employed and they are preferably selected from water soluble or dispersible triglyceride oils such as hydrophilically modified animal oils; hydrophilically modified synthetic oils; hydrophilically modified vegetable oils; and blends thereof; more preferably selected from vegetable oils, fish oils, tall oils, tallow, lard, and lanolin; more preferably from sulfated castor oil, sulfated canola oil, sulfonated castor oil, sulfonated canola oil, ethoxylated lanolin, sulfated lanolin, sulfonated lanolin, sulfated fish oil, sulfonated fish oil, sulfated lard oil, sulfonated lard oil, ethoxylated tall oil, sulfated tall oil and sulfonated tall oil, ethoxylated triglycerides, sulfated tallow, sulfonated tallow, sulfated lard and sulfonated lard.

Preferably the laundry detergent composition has about 10 to about 60 wt. % of a surfactant. Advantageously the color fading and fabric wear reducing agent is present in an amount effective to reduce color fading and fabric wear in laundered clothing, preferably in the range of about 0.5 wt % to about 15 wt % of the composition, more preferably in the range of about 1 wt % to about 7 wt % of the composition. Advantageously the laundry composition is in a form selected from a liquid, powder, paste, granule, or molded solid.

Advantageously the inventive laundry composition further comprises additional cleaning adjunct materials selected from bleaching agents, builders, alkalinity sources, and mixtures thereof; and enzymes, chelants, soil releasing agents, dye transfer inhibiting agents, fabric softening agents, and mixtures thereof.

Advantageously the detergent composition may be added to a twin tub washing machine to provide from about 15 ppm to 430 ppm of said color fading and fabric wear reducing agent, preferably from about 30 ppm to 200 ppm. Advantageously the detergent composition may be added to a vertical axis washing machine to provide from about 10 ppm to 280 ppm of said color fading and fabric wear reducing agent, preferably from 20 ppm to 130 ppm. Advantageously the detergent composition may also be added to a horizontal axis washing machine to provide from about 25 ppm to 780 ppm of said color fading and fabric wear reducing agent, preferably from 50 ppm to 360 ppm.

The inventive method is suitably applied to fabrics made from natural fibers, synthetic fibers or a blend thereof; preferably selected from cotton, rayon and polyester.

Suitable inventive kits are provided preferably where the laundry composition and color fading and fabric wear reducing agent are preblended together and packaged in at least one container. Preferably the inventive kit contains at least one water soluble or dispersible triglyceride oils selected from hydrophilically modified animal oils; hydrophilically modified synthetic oils; hydrophilically modified vegetable oils; and blends thereof, more preferably selected from vegetable oils, fish oils, tall oils, tallow, lard, and lanolin; most preferably selected from sulfated castor oil, sulfated canola oil, sulfonated castor oil, sulfonated canola oil, ethoxylated lanolin, sulfated lanolin, sulfonated lanolin, sulfated fish oil, sulfonated fish oil, sulfated lard oil, sulfonated lard oil, ethoxylated tall oil, sulfated tall oil and sulfonated tall oil, ethoxylated triglycerides, sulfated tallow, sulfonated tallow, sulfated lard and sulfonated lard.

Advantageously the laundry detergent composition has about 10 to about 60 wt. % of a surfactant. Preferably the color fading and fabric wear reducing agent is present in an amount effective to reduce the occurrence of wrinkles in laundered clothing, preferably in the composition in the range of about 0.5 wt % to about 15 wt % of the composition, more preferably in the range of about 1 wt % to about 7 wt % of the composition. Preferably the composition is in a form selected from a liquid, powder, paste, granule, or molded solid.

The kit may optionally be used with instructions indicating the addition of the laundry composition to a twin tub washing machine to provide from about 15 ppm to 430 ppm of said color fading and fabric wear reducing agent, preferably from 30 ppm to 200 ppm.

The kit may also optionally be used with instructions indicating the addition of the laundry composition to a vertical axis washing machine to provide from about 10 ppm to 280 ppm of said color fading and fabric wear reducing agent, preferably from about 20 ppm to 130 ppm.

The kit may also optionally be used with instructions indicating the addition of the laundry composition to an horizontal axis washing machine to provide from about 25 ppm to 780 ppm of said color fading and fabric wear reducing agent, preferably from about 50 ppm to 360 ppm.

The kit may optionally contain a laundry composition including additional cleaning adjunct materials selected from bleaching agents, builders, alkalinity sources, and mixtures thereof; and enzymes, chelants, soil releasing agents, dye transfer inhibiting agents, fabric softening agents, and mixtures thereof.

The kit may also be optionally be used with fabrics composed of natural fibers, synthetic fibers or a blend thereof, preferably selected from cotton, rayon and polyester.

Silicone and Acrylamide Polymers

Useful silicone and acrylamide polymers in the present invention include polyalkyleneoxide modified polydimethylsiloxane; linear aminopolydimethylsiloxane polyalkyleneoxide copolymers; high molecular weight polyacrylamides; betaine siloxane copolymers; and alkylactam siloxane coplymers.

Triglyceride Oils

Typically such triglyceride derivatives can be prepared using art recognized techniques via reaction with one or more hydroxyl groups, unsaturated sites, or a combination thereof in the oil or wax. Other suitable water soluble or dispersible triglyceride oil derivatives may be prepared by transesterifcation using art recognized techniques with e.g. alkanolamines such as triethanolamine and/or its alkoxylated derivatives. Suitable methods for transesterifying triglyceride oils may be found in e.g. U.S. Pat. No. 6,271,185 issued to Kodall et al. on Aug. 7, 2001 which is incorporated herein in its entirety. Other suitable water soluble or dispersible triglyceride oil derivatives having polyunsaturated fatty acids include adducts which are conjugated and then modified via Diels-Alder addition with acrylic acid, fumaric acid, maleic anhydride and the like.

Various levels of derivatization may be used provided that the derivatization level is sufficient for the oil or wax derivatives to become water soluble or dispersible so as to exert a wrinkle reduction effect during laundering of fabrics with a detergent containing the oil or wax derivative.

Suitable alkoxylated plant and animal derived and synthetic triglyceride oil derivatives may include ethoxylated, propoxylated, or a combination thereof as illustrated in the following structure:

TG-((OCH₂CH₂O)ₓ(OCHCH₃CH₂)_{y}OR)ₙ (1)

TG=Triglyceride radical;

n=1, 2 or 3;

R=H; C₁-C₂₀ alkyl, C₁-C₂₀ alkenyl, C₁-C₂₀ alkylaryl, aryl, or heterocyclic; either substituted or unsubstituted.

x=an integer from 1 to 50; y=an integer from 0 to 50; x and y groups may be in either a random or a blocked arrangement.

Suitable saccharide modified plant and animal derived and synthetic triglyceride oil derivatives may include monosaccharides, disaccharides and polysaccharides e.g. sucrose, glucose, maltose and the like, or a combination thereof as illustrated in the following structure:

TG-(Saccharide)ₙ (2)

TG=Triglyceride radical;

n=1, 2 or 3.

Suitable sulfated plant and animal derived and synthetic triglyceride oil derivatives may include compounds as illustrated by the following structure:

TG-(OSO₂OM)ₙ (3)

TG=Triglyceride radical;

n=1, 2 or 3;

M is H or a cation such as Na, K, Li, NH₄, Ca, or Mg and the like.

Suitable sulfonated plant and animal derived and synthetic triglyceride oil derivatives may include compounds as illustrated by the following structure:

TG-(C(O)(CH₂)_{z}S(O₂)OM)ₙ (4)

TG=Triglyceride radical;

n=1, 2 or 3;

z is an integer from 1 to 20, preferably from 1 to 5.

M is H or a cation such as Na, K, Li, NH₄, Ca, or Mg and the like.

Suitable carboxylated plant and animal derived and synthetic triglyceride oil derivatives may include compounds as illustrated by the following structure:

TG-(C(O)(CH₂)_{z}C(O)OM)ₙ (5)

TG=Triglyceride radical;

n=1, 2 or 3;

z is an integer from 1 to 20, preferably from 1 to 5.

M is H or a cation such as Na, K, Li, NH₄, Ca, or Mg and the like.

Suitable peptide modified plant and animal derived and synthetic triglyceride oil derivatives may include monopeptides, dipeptides, and polypeptides as illustrated by the following structure:

TG-(peptide(s))ₙ (6)

TG=Triglyceride radical;

n=1, 2 or 3.

Suitable commercially available ethoxylated and alkoxylated derivatives include: castor oil products such as Stepantex CO-30, Stepantex CO-36 and Stepantex CO-40 ethoxylated castor oil products and Stepantex HCO-5 a hydrogenated castor oil alkoxylate, the Ethox CO line of products (ethoxylated castor oil), and the like, from Ethox Chemicals (Greenvile, S.C.) and, the Hetoxide C line of products (ethoxylated castor oil), and the like, from Heterene Chemical (Paterson, N.J.); tall oil derivatives such as Ethofat 242/25, an ethoxylated tall oil, and the like, available from Akzo Nobel; and, lanolin derivatives such as Lan-Aqua-Sol 4:50 (lanolin ethoxylate) and Fancol HL-20 (a hydrogenated lanolin ethoxylate), and the like.

Suitable triglyceride oil derivatives may be prepared by esterification to a sufficient level for the triglyceride oil derivatives to become water soluble or dispersible so as to exert a wrinkle reduction effect during laundering of fabrics with a detergent containing the esterified triglyceride oil derivative. Any suitable compound may be used to esterify the triglyceride oil including linear, alpha-omega dicarboxylic acids.

Suitable commercially available triglyceride oil derivatives include Freedom STW-80 (sulfated tallow), Solocod G (sulfated fish oil), and Freedom SLO-75 (sulfated lard oil), and the like, available from Noveon (Cleveland, Ohio); Lowenol NZB (sulfated lanolin), and the like, available from Lowenstein and Sons (Brooklyn, N.Y.); and, Fancol ACEL (acylated lanolin), and the like, available from Thornley Co (Wilmington, Del.), and sulfated canola oil and/or castor oil available from Freedom Chemical Co., Charlotte, N.C.

One or more of the molecules/compounds from the above-identified classes of inventive hydrophilically modifed triglyceride oils are preferably included in known detergent compositions in an effective amount sufficing to reduce the occurrence of wrinkles as compared to clothing laundered and dried in a similar manner with a detergent composition that excludes the color fading and fabric wear reducing agents. An effective amount of the color fading and fabric wear reducing ingredient is preferably from about 0.5 wt % to about 15 wt % and most preferably from about 1 wt % to about 7 wt %. Suitable liquid detergent compositions are described, for example, in U.S. Pat. Nos. 4,261,868; 4,322,308; 4,959,179; 5,089,163; 5,147,576; and 5,205,957, all of which are incorporated herein by reference.

Of the foregoing, a most preferred color fading and fabric wear reduction agent is a polyalkyleneoxide modified polydimethylsiloxane, sold under the name Silwet L-7622, available from Witco, Greenwich, Conn. Other most preferred color fading and fabric wear reduction agents are sulfated canola oil and/or castor oil available from Freedom Chemical Co., Charlotte, N.C.

An additional advantage of the above-identified color fading and fabric wear reducing ingredients is that the molecules/compounds do not have a net positive charge in a neutral or alkaline medium, i.e. a medium having a pH greater than or equal to about 6.5. Lack of a net positive charge makes their inclusion in liquid detergents containing anionic surfactants much easier. More specifically, they are less likely to precipitate with negatively charged surfactants.

Except in the operating and comparative examples, or where otherwise explicitly indicated, all numbers in this description indicating amounts of material ought to be understood as modified by the word “about”.

The following examples will more fully illustrate the embodiments of this invention. All parts, percentages and proportions referred to herein and in the appended claims are by weight unless otherwise illustrated. Physical test methods are described below:

### TEST METHOD AND EXAMPLES

### Example 1

### Pilling Reduction Benefit

Two experimental laundry detergents containing 4% Sulfated Castor Oil (SCO) and 8% SCO are compared against the control (No SCO).

8% SCO

| | | % as is in final |
|---|---|---|
| | Ingredient | formulation |
| Phase A | | |
| | Water | 10 |
| | Sorbitol Solution (70%) | 3.44 |
| | Sodium Borate (Pentahydrate) | 2.38 |
| Phase B | | |
| | Alcohol Ethoxylate | 5.15 |
| | Water | 3.5 |
| | Optical Brightener | 0.20 |
| Phase C | | |
| | Water | 27 |
| | Sodium Citrate | 2.5 |
| | Propylene Glycol | 5.11 |
| | Phase A | (15.82) |
| | Monoethanolamine | 0.18 |
| | Coconut Oil Fatty Acid | 0.60 |
| | Sodium Hydroxide 50% | 0.84 |
| Agitated 15 minutes to | Alkylbenzenesulfonic Acid | 4.0 |
| allow for complete | | |
| neutralization. | | |
| Agitated 15 minutes to | Alcohol Ethoxysulfate Blend¹ | 11.9 |
| allow for homogenous | | |
| mixing. | | |
| | Phase B | (8.85) |
| | Preservative | 0.02 |
| | Soil Release Polymer² | 0.65 |
| | Sulfated Castor Oil, 50% | 16 |
| | Solution³ | |
| | Proteolytic Enzyme | 0.17 |
| | Lipolytic Enzyme | 0.43 |
| | Water | Qs to 100 |

¹A mixture of 60% Alcohol Ethoxysulfate, 11% Propylene Glycol, 6.5% Ethanol and 22.5% water.
²preferred soil release polymers are the Repel-O-Tex range from Rhodia (Cranbury, NJ) and the Sokalan range from BASF (Mount Olive, NJ)
³Available, from Noveon, Cleveland, OH.

All ingredients in Phase A were combined, brought to 40° C. and stirred for 30 minutes at 400 rpm using an IKA RW 20 DZM.n motorized stirrer with a paddle impeller.

The nonionic surfactant for Phase B was heated to 50C, agitated at 300 rpm using an IKA RW 20 DZM.n motorized stirrer with a paddle impeller, after which the water for Phase B was added and stirred for 5 minutes. Following this, the optical brightener was dosed to the phase under continued agitation, after which Phase B was permitted to mix for 30 minutes to ensure complete dissolution of all ingredients.

All ingredients for Phase C, the final product, were added in the order shown in the above table, under continued agitation at 400 rpm using an IKA RW 20 DZM.n mechanical stirrer equipped with a paddle impeller. No heating took place during the batching of Phase C. Except as noted, the mixture was permitted to agitate for 5 minutes between additions. Following the final water, the batch was mixed for an additional 30 minutes to ensure that the formula was homogenous.

4% SCO

| | | % as is in final |
|---|---|---|
| | Ingredient | formulation |
| Phase A | | |
| | Water | 10 |
| | Sorbitol Solution (70%) | 3.44 |
| | Sodium Borate | 2.38 |
| | (Pentahydrate) | |
| Phase B | | |
| | Alcohol Ethoxylate | 5.15 |
| | Water | 3.5 |
| | Optical Brightener | 0.20 |
| Phase C | | |
| | Water | 27 |
| | Sodium Citrate | 2.5 |
| | Propylene Glycol | 5.11 |
| | Phase A | (15.82) |
| | Monoethanolamine | 0.18 |
| | Coconut Oil Fatty Acid | 0.60 |
| | Sodium Hydroxide 50% | 0.84 |
| Agitated 15 minutes to | Alkylbenzenesulfonic Acid | 4.0 |
| allow for complete | | |
| neutralization. | | |
| Agitated 15 minutes to | Alcohol Ethoxysulfate | 11.9 |
| allow for homogenous | Blend⁴ | |
| mixing. | | |
| | Phase B | (8.85) |
| | Preservative | 0.02 |
| | Soil Release Polymer | 0.65 |
| | Sulfated Castor Oil, 50% | 8 |
| | Solution⁵ | |
| | Proteolytic Enzyme | 0.17 |
| | Lipolytic Enzyme | 0.43 |
| | Water | Qs to 100 |

⁴A mixture of 60% Alcohol Ethoxysulfate, 11% Propylene Glycol, 6.5% Ethanol and 22.5% water.

All ingredients in Phase A were combined, brought to 40° C. and stirred for 30 minutes at 400 rpm using an IKA RW 20 DZM.n motorized stirrer with a paddle impeller.

The nonionic surfactant for Phase B was heated to 50C, agitated at 300 rpm using an IKA RW 20 DZM.n motorized stirrer with a paddle impeller, after which the water for Phase B was added and stirred for 5 minutes. Following this, the optical brightener was dosed to the phase under continued agitation, after which Phase B was permitted to mix for 30 minutes to ensure complete dissolution of all ingredients.

All ingredients for Phase C, the final product, were added in the order shown in the above table, under continued agitation at 400 rpm using an IKA RW 20 DZM.n mechanical stirrer equipped with a paddle impeller. No heating took place during the batching of Phase C. Except as noted, the mixture was permitted to agitate for 5 minutes between additions. Following the final water, the batch was mixed for an additional 30 minutes to ensure that the formula was homogenous.

Fabric that is prone to pilling was selected for this experiment (100% woven polyester with spun yarn). Two replicates of this fabric (24″×24″) were washed in consecutive hot and warm water cycles (2 warm water and 1 hot water cycle) with 5.5 lbs of ballast load. Tests were conducted in accordance with the washing procedures provided under American Association of Textile Chemist and Colorist (AATCC) Method #124, Appearance of Fabrics after Repeated Home Laundering. Samples were dried after each wash cycle at cotton setting for 10 minutes in a tumble drier using AATCC 124. These samples were washed and dried continually for 12 cycles. Visual pilling assessment was made on these samples under standard Cool White fluorescent light. Fabrics were held in the light at an angle so as to enhance the surface pilling visualization.

Visual side-by-side comparisons were made by 10 panelists on fabric treated with detergent containing 4% SCO vs control and 8% SCO vs control to determine which fabric treatment showed less pilling. Results are listed in table 1 below:

TABLE 1
Pilling Results on Sulfated Castor Oil Treated Fabrics after 12
wash/dry cycles.

| | % Panelists picking Treated fabric over | |
|---|---|---|
| Product | the Control | Confidence Level |
| 4% SCO | 85% | 99.83 |
| 8% SCO | 100% | 99.99 |

### Example 2

### Color Fading Reduction Benefits

Two colored fabrics (2 replicates each) charcoal (55% Acrylic, 45% Cotton) and a black (100% Cotton) fabric were washed in consecutive hot and warm water wash cycle (2 warm water and 1 hot water cycle) with 5.5 lbs of ballast load. Tests were conducted in accordance with the washing procedures provided under American Association of Textile Chemist and Colorist (AATCC) ⁵Available, from Noveon, Cleveland, Ohio.

Method #124, Appearance of Fabrics after Repeated Home Laundering. Samples were then dried for 60 minutes in cotton high setting using AATCC Method #124. Samples were washed and dried continually for 24 cycles. Comparative visual assessment was then made under D65 lighting condition. Nine panelists were asked to pick the fabric that appeared ‘less faded’ by comparing fabrics treated with prototypes containing 4% SCO vs control or 8% SCO vs control. Following results are reported in Table 2 below:

TABLE 2
Color Evaluations of various fabrics after 24 wash/dry cycles.

| | % Panelists picking Treated fabric over the Control and its | | | |
|---|---|---|---|---|
| | confidence level | | | |
| Fabric | 4% SCO | CL | 8% SCO | CL |
| Charcoal | 94.4% | 99.98 | 83.3% | 99.53 |
| Black | 72.2% | 94.07 | 94.4% | 99.98 |

*CL—Confidence Level

The following formulations containing a color fading and fabric wear reduction ingredient show preferred ranges of ingredients in accordance with the present invention. Formulations 1 to 3 represent liquid laundry detergents. Formulations 4 and 5 represent powdered and tableted detergent compositions respectively. Formulations 5 and 7 represent detergents having ethoxylated organosilicone copolymers as the color fading and fabric wear reducing agent while formulations 6 and 8 represent detergents having sulfated castor oil as the color fading and fabric wear reducing agent. Formulations 9 and 10 represent powdered and tabulated formulations, respectfully.

Formulation 3

| Ingredient | Percent in Formula (by weight) |
|---|---|
| sodium alcohol ethoxy sulfate | 11.0 |
| 9EO alcohol ethoxylate | 6.0 |
| sodium linear alkyl benzene sulfonate | 6.0 |
| propylene glycol | 4.0 |
| Sorbitol | 3.5 |
| Borax | 2.0 |
| sodium citrate | 1.5 |
| Silwet L-7622* | 1.0 |
| protease enzyme | 0.25 |
| lipase enzyme | 0.5 |
| Water | to 100% |

*Color fading and fabric wear reduction agent—polyoxyalkylene modified polydimethylsiloxane from Witco Chemical Co.

Formulation 4

| Ingredient | Percent in Formula |
|---|---|
| sodium alcohol ethoxy sulfate | 11.0 |
| 9EO alcohol ethoxylate | 6.0 |
| sodium linear alkyl benzene sulfonate | 6.0 |
| propylene glycol | 4.0 |
| Sorbitol | 3.5 |
| Borax | 2.0 |
| sodium citrate | 1.5 |
| Freedom Scano-75* | 1.0 |
| protease enzyme | 0.25 |
| lipase enzyme | 0.5 |
| Water | to 100% |

*Color fading and fabric wear reduction agent—sulfated canola oil from Freedom Chemical Co.

FORMULATION 5

| | Percent in Formula (Based on |
|---|---|
| Ingredient—Chemical Name | 100% Active Raw) |
| Alcohol Ethoxylate | 4.0-15.0 |
| Sodium Alkyl Ethoxy Sulfate | 7.0-25.0 |
| Alkylbenzene Sulfonic Acid | 4.0-15.0 |
| Sodium Hydroxide | 0.3-2.5 |
| Propylene Glycol | 2.0-10.0 |
| Sorbitol | 2.0-10.0 |
| SODIUM TETRABORATE | 2.0-10.0 |
| Sodium Citrate Dihydrate | 1.5-10.0 |
| Ethoxylated Organosilicone | 0.5-5.0 |
| Copolymer | |
| COCONUT FATTY ACID | 0.4-2.5 |
| FLUORESCENT WHITENING | 0.1-0.6 |
| ANTIREDEPOSITION AGENT | 0.15-1.5 |
| Enzyme—Protease | 0.15-1.5 |
| Enzyme—Lipase | 0-2.0 |
| Monoethanolamine | 0.1-1.5 |
| Perfume | 0.1-1.0 |
| WATER To 100% | |

FORMULATION 6

| | Percent In Formula (Based On |
|---|---|
| Ingredient—Chemical Name | 100% Active Raw) |
| Alcohol Ethoxylate | 4.0-15.0 |
| Sodium Alkyl Ethoxy Sulfate | 7.0-25.0 |
| Alkylbenzene Sulfonic Acid | 4.0-15.0 |
| Sodium Hydroxide | 0.3-2.5 |
| Propylene Glycol | 2.0-10.0 |
| Sorbitol | 2.0-10.0 |
| Sodium Tetraborate | 2.0-10.0 |
| Sodium Citrate Dihydrate | 1.5-10.0 |
| Sulfated Castor Oil | 0.5-10.0 |
| Coconut Fatty Acid | 0.4-2.5 |
| Fluorescent Whitening Agent | 0.1-0.6 |
| Antiredeposition Agent | 0.15-1.5 |
| Enzyme—Protease | 0.15-1.5 |
| Enzyme—Lipase | 0-2.0 |
| Monoethanolamine | 0.1-1.5 |
| Perfume | 0.1-1.0 |
| Water To 100% | |

FORMULATION 7

| | Percent in Formula (Based on |
|---|---|
| Ingredient—Chemical Name | 100% Active Raw) |
| ALCOHOL ETHOXYLATE | 3.5-20.0 |
| ALKYLBENZENE SULFONIC | 9.5-30.0 |
| ACID | |
| SODIUM HYDROXIDE | 1.0-10.0 |
| ETHOXYLATED | 0.5-5.0 |
| ORGANOSILICONE | |
| COPOLYMER | |
| SODIUM XYLENE | 0.75-10.0 |
| SULFONATE | |
| STEARIC ACID | 0.09-0.5 |
| SODIUM SILICATE | 2.0-12.0 |
| FLUORESCENT | 0.04-0.4 |
| WHITENING AGENT | |
| PERFUME | 0.1-1.0 |
| WATER to 100% | |

FORMULATION 8

| | Percent in Formula (Based on |
|---|---|
| Ingredient—Chemical Name | 100% Active Raw) |
| ALCOHOL ETHOXYLATE | 3.5-20.0 |
| ALKYLBENZENE | 9.5-30.0 |
| SULFONIC ACID | |
| SODIUM HYDROXIDE | 1.0-10.0 |
| SULFATED CASTOR OIL | 0.5-10.0 |
| SODIUM XYLENE | 0.75-10.0 |
| SULFONATE | |
| STEARIC ACID | 0.09-0.5 |
| SODIUM SILICATE | 2.0-12.0 |
| FLUORESCENT | 0.04-0.4 |
| WHITENING AGENT | |
| PERFUME | 0.1-1.0 |
| WATER to 100% | |

FORMULATION 9 (Detergent Powder)

| | |
|---|---|
| Linear alkylbenzene sulfonate | 13.8% |
| (LAS) | |
| Ethoxylated nonionics (5 to 15 | 5.2% |
| moles EO) | |
| Sodium aluminosilicate | 28% |
| Sodium carbonate | 20% |
| Sodium sulfate | 18% |
| Sodium silicate | 0.5% |
| Polyacrylates | 1.4 |
| Sodium perborate | 0 to 8% |
| Protease enzyme | 0.5% |
| Perfume | 0.4% |
| Fluorescent Whitener | 0.3% |
| Anti-Color fading and fabric | See Table A |
| wear agent | |
| Water and miscellaneous | to 100% |

Formulation 10 (Detergent Tablet)

FORMULATION 10 (Detergent Tablet)

| | |
|---|---|
| Linear alkylbenzene sulfonate | 9.4% |
| Ethoxylated nonionics (5 to 15 | 4% |
| mole EO) | |
| Sodium aluminosilicate | 25% |
| Sodium carbonate | 24.5% |
| Sodium sulfate | 5.4% |
| Sodium Acetate trihydrate | 25% |
| Fluorescent whitener | 0.3% |
| Stearic soap | 0.75% |
| Perfume | 0.4% |
| Protease enzyme | 0.5% |
| Polyacrylates | 1.2% |
| Anti-Color fading and fabric | See Table A |
| wear ingredients | |
| Water and miscellaneous | to 100% |

TABLE 3
Color fading and wear reduction ingredients.

| COMPONENT | CONCENTRATION RANGE |
|---|---|
| Ethoxylated organosilicones | 1-10% |
| Polyalkyleneoxide modified | 1-10% |
| polydimethylsiloxane | |
| Linear | 1-10% |
| aminopolydimethylsiloxane | |
| polyalkyeneoxides | |
| Sulfated oil | 1-10% |

Components in Table 3 can either be used individually or in combination with the total level being preferably between about 1 to about 10%. Other useful hydrophilically modified triglyceride oils include the following: Ethox CO-16 (POE-16 castor oil) and Ethox CO-25 (POE-25 castor oil) both available from Ethox Chemical Co.; Freedom STW-80 (sulfated tallow), Solocod G (sulfated fish oil), and Freedom LO-75 (sulfated lard oil) available from Noveon; Lowenol NZB (sulfated lanolin) available from Lowenstein and Sons; Ethofat 242/25 (ethoxylated tall oil) available from Akzo Nobel; Lan-Aqua-Sol 4:50 (lanolin ethoxylate), Fancol HL-20 (hydrogenated lanolin ethoxylates), and Fancol ACEL (acylated lanolin) available from Thornley Co.

The above-identified color fading and fabric wear reducing agents are preferably incorporated in detergent compositions that contain at least one anionic surfactant. More preferably, the detergent compositions contain at least one nonionic surfactant in addition to the anionic surfactant.

Typically one wash with a detergent prepared with and without the inventive color fading and fabric wear reducing agent is performed using 2 approximately 40 g detergent tablets in 17 gallons of water at 95F.

The above-identified color fading and fabric wear reducing agents may be incorporated in liquid, powdered/granular, semi-solid or paste, and molded solid or tablet compositions. Suitable powdered/granular composition are well known commercially available, for example, under the brand names Wisk (Unilever) and Tide (Procter and Gamble).

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

What is claimed is:

1. A method of reducing the color fading and fabric wear damage to laundered fabric that is subjected to multiple wash cycles, comprising the steps of:
providing a detergent composition comprising at least one color fading and fabric wear reducing agent selected from polyalkyleneoxide modified polydimethylsiloxane, linear aminopolydimethylsiloxane polyalkyleneoxide copolymers, high molecular weight polyacrylamides, betaine siloxane copolymers, alkylactam siloxane coplymers, and water soluble or dispersible triglyceride oils;
contacting the detergent composition with clothing during a washing procedure; and
allowing the clothing to dry; wherein the laundered clothing has less visible color fading and fabric wear than clothing laundered and dried in a similar manner with a detergent composition that excludes the at least one color fading and fabric wear reducing agent.

2. The method of claim 2 wherein the water soluble or dispersible triglyceride oils is selected from hydrophilically modified animal oils; hydrophilically modified synthetic oils; hydrophilically modified vegetable oils; and blends thereof.

3. The method of claim 1, wherein said laundry detergent composition has about 10 to about 60 wt. % of a surfactant.

4. The method of claim 1, wherein at least one of the color fading and fabric wear reducing agents is present in an amount effective to reduce color fading and fabric wear in laundered clothing.

5. The method of claim 1, wherein at least one of the color fading and fabric wear reducing agents is present in the composition in the range of about 0.5 wt % to about 15 wt % of the composition.

6. The method of claim 1, wherein the composition is in a form selected from a liquid, powder, paste, granule, or molded solid.

7. The method of claim 1 wherein the triglyceride color fading and fabric wear reducing agent is selected from vegetable oils, fish oils, tall oils, tallow, lard, and lanolin.

8. The method of claim 7 wherein the triglyceride color fading and fabric wear reducing agent is selected from sulfated castor oil, sulfated canola oil, sulfonated castor oil, sulfonated canola oil, ethoxylated lanolin, sulfated lanolin, sulfonated lanolin, sulfated fish oil, sulfonated fish oil, sulfated lard oil, sulfonated lard oil, ethoxylated tall oil, sulfated tall oil and sulfonated tall oil, ethoxylated triglycerides, sulfated tallow, sulfonated tallow, sulfated lard and sulfonated lard.

9. The method of claim 1 wherein said composition further comprises additional cleaning adjunct materials selected from bleaching agents, builders, alkalinity sources, and mixtures thereof.

10. The method of claim 1 wherein said composition further comprises additional cleaning adjunct materials selected from enzymes, chelants, soil releasing agents, dye transfer inhibiting agents, fabric softening agents, and mixtures thereof.

11. The method of claim 1 wherein said detergent composition is added to a twin tub washing machine to provide from about 15 ppm to 430 ppm of said color fading and fabric wear reducing agent.

12. The method of claim 1 wherein said detergent composition is added to a vertical axis washing machine to provide from about 10 ppm to 280 ppm of said color fading and fabric wear reducing agent.

13. The method of claim 1 wherein said detergent composition is added to a horizontal axis washing machine to provide from about 25 ppm to 780 ppm of said color fading and fabric wear reducing agent.

14. The method of claim 1 wherein said fabric is made from natural fibers, synthetic fibers or a blend thereof.

15. A method of reducing the occurrence of color fading and fabric wear damage in laundered clothing comprising:
providing a detergent formulation comprising at least one color fading and fabric wear reducing agent selected from compounds that to do not have a net positive charge;
contacting the detergent formulation with clothing during a washing procedure; and
allowing the clothing to dry; wherein the laundered clothing has less visible color fading and fabric wear than clothing laundered and dried in a similar manner with a detergent formulation that excludes the at least one color fading and fabric wear reducing agent.

16. A laundry detergent composition kit comprising:
a laundry detergent composition including at least one surfactant;
at least one color fading and fabric wear reducing agent;
the laundry detergent composition and color fading and fabric wear reducing agent packaged in at least one container;
instructions to use the laundry detergent composition and color fading and fabric wear reducing agent at a level that will provide from about 10 to 780 ppm of the color fading and fabric wear reducing agent in the aqueous wash solution to provide a benefit that color fading and fabric wear is reduced in a fabric as compared to a comparable treatment with a lower level of, or the absence of the color fading and fabric wear reducing agent.

17. The kit of claim 16 wherein the laundry composition and color fading and fabric wear reducing agent are preblended together and packaged in at least one container.

18. The kit of claim 16 wherein the water soluble or dispersible triglyceride oils is selected from hydrophilically modified animal oils; hydrophilically modified synthetic oils; hydrophilically modified vegetable oils; and blends thereof.

19. The kit of claim 16 wherein said laundry detergent composition has about 10 to about 60 wt. % of a surfactant.

20. The kit of claim 16 wherein at least one of the color fading and fabric wear reducing agents is present in an amount effective to reduce the occurrence of wrinkles in laundered clothing.

21. The kit of claim 16 wherein at least one of the color fading and fabric wear reducing agents is present in the composition in the range of about 0.5 wt % to about 15 wt % of the composition.

22. The kit of claim 16 wherein the composition is in a form selected from a liquid, powder, paste, granule, or molded solid.

23. The kit of claim 18 wherein the triglyceride color fading and fabric wear reducing agent is selected from vegetable oils, fish oils, tall oils, tallow, lard, and lanolin.

24. The kit of claim 23 wherein the triglyceride color fading and fabric wear reducing agent is selected from sulfated castor oil, sulfated canola oil, sulfonated castor oil, sulfonated canola oil, ethoxylated lanolin, sulfated lanolin, sulfonated lanolin, sulfated fish oil, sulfonated fish oil, sulfated lard oil, sulfonated lard oil, ethoxylated tall oil, sulfated tall oil and sulfonated tall oil, ethoxylated triglycerides, sulfated tallow, sulfonated tallow, sulfated lard and sulfonated lard.

25. The kit of claim 16 wherein said composition further comprises additional cleaning adjunct materials selected from bleaching agents, builders, alkalinity sources, and mixtures thereof

26. The kit of claim 16 wherein said composition further comprises additional cleaning adjunct materials selected from enzymes, chelants, soil releasing agents, dye transfer inhibiting agents, fabric softening agents, and mixtures thereof.

27. The kit of claim 16 wherein said instructions indicate addition to a twin tub washing machine to provide from about 15 ppm to 430 ppm of said color fading and fabric wear reducing agent.

28. The kit of claim 16 wherein said instructions indicate addition to a vertical axis washing machine to provide from about 10 ppm to 280 ppm of said color fading and fabric wear reducing agent.

29. The kit of claim 16 wherein said instructions indicate addition to an horizontal axis washing machine to provide from about 25 ppm to 780 ppm of said color fading and fabric wear reducing agent.

30. The kit of claim 16 wherein said fabric is made from natural fibers, synthetic fibers or a blend thereof.
